(19) United States
(12) Patent Application Publication
(10) Pub. No.: US 2025/0260922 A1
(43) Pub. Date: Aug. 14, 2025

(54) BANDPASS QUASI-STEREO WOOFER

(71) Applicant: Panasonic Automotive Systems Company of America, Division of Panasonic Corporation of North America, PEACHTREE CITY, GA (US)

(72) Inventors: ANTHONY THOMPSON, TROY, MI (US); MARK ZIEMBA, SOUTHFIELD, MI (US)

(21) Appl. No.: 18/952,106

(22) Filed: Nov. 19, 2024

Related U.S. Application Data
(60) Provisional application No. 63/551,726, filed on Feb. 9, 2024.

(51) Int. Cl. H04R 1/34; B60R 11/00; B60R 11/02; H04R 1/28

(52) U.S. Cl. CPC H04R 1/345; B60R 11/0217; H04R 1/2849; B60R 11/00; B60R 2011/0007; H04R 2499/13

(57) ABSTRACT

This invention involves a novel implementation of a double-tuned bandpass enclosure installed in a motor vehicle. The enclosure contains a woofer or subwoofer emitting sound through a pair of extended ports to two discrete points of acoustic termination. The enclosure includes a primary and a secondary through-hole, in which the primary through-hole originates from a front chamber and secondary originates from a rear chamber. The first through-hole is connected to an elongated port which transmits a portion of the sound into the vehicle passenger compartment at a primary location. A second elongated port is coupled to the secondary through-hole, which transmits a portion of the sound to a second location, separate from the first. The sound emitted at the two locations represent different but complementary frequency responses, thereby creating a quasi-stereo environment.

### CROSS-REFERENCED TO RELATED APPLICATIONS

This application claims benefit of U.S. Provisional Application No. 63/551,726, filed on Feb. 9, 2024, the disclosure of which is hereby incorporated by reference in its entirety for all purposes.

### BACKGROUND OF THE INVENTION

### 1. Field of the Invention

The present invention relates to automotive audio systems.

### 2. Description of the Related Art

Compact audio is a new audio system format that has arisen in the electric vehicle (EV) market. A compact audio system employs less than four speakers with an emphasis on weight, size, and reduced complexity. A typical application may use two high frequency drivers coupled with a single larger loudspeaker to augment lower frequencies.

The most significant problem of low frequency distribution in a compact audio system is that a solo speaker tends to project bass from a single location. This breaks the basic tenets of stereo sound delivery, with there being no difference in perceived location and content between the left and right input channels coming out of the loudspeaker.

The primary problem in compact audio is one of adequate bass delivery in a localized, compact format that also allows for efficiency. As such, there are not many examples to compare against. Prototypical systems that have been revealed at trade shows and conferences are typically one-piece solutions that house a single dash-or console-based woofer, coupled with additional high frequency drivers. Such systems will inevitably have problems with full bandwidth stereo when employed in a production vehicle.

### SUMMARY OF THE INVENTION

The invention addresses the above-described problem of a compact audio system by creating two discrete locations in the vehicle where bass is delivered, thereby creating a quasi-stereo environment. That is, the invention addresses the issue of bass coming from a single location by delivering bass sounds from two different locations in the vehicle cabin, thereby emulating a quasi-stereo environment with a single woofer.

The invention may provide a critical, singular component of a compact audio system, and a unique application of low frequency audio delivery.

The invention may provide a woofer that is completely housed within a double-tuned enclosure. Two elongated ports may extend from the enclosure, one port originating from a front chamber and another port originating from a rear chamber.

The invention may provide double extended ports to reach the points of acoustic termination, while the loudspeaker remains housed and hidden in a centrally located enclosure. An advantage of this inventive arrangement is that the loudspeaker can be mounted in a central location under the dashboard or within a center console.

The invention comprises, in one form thereof, a compact audio woofer arrangement for a motor vehicle, including an enclosure installed in the motor vehicle. The enclosure contains a double-tuned bandpass woofer emitting sound. The enclosure includes a primary and secondary through-hole, in which an elongated port is coupled to each through-hole. The first elongated port carries a first portion of the sound from the enclosure to a first location remote from the enclosure such that the first portion of the sound is emitted into the passenger compartment at the first location. The secondary elongated port carries a second portion of the sound from the enclosure to a second location remote from the enclosure such that the second portion of the sound is emitted into the adjacent passenger compartment at the second location. The sound emitted from both locations represent different but complementary frequency responses.

The invention comprises, in yet another form thereof, a configuration identical to the aforementioned solution, although with the addition of a digital signal processing (DSP)-based sound mixing implementation that supplies the woofer with a unique equalization applied to each channel. By emphasizing certain frequency ranges of one input channel and de-emphasizing the same frequency ranges in the other input channel, the stereo effect is effectively enhanced out of each output location.

As shown in FIG. 2 and FIG. 3, the acoustic response of each of the two outputs sources differs significantly, creating a quasi-stereo effect between the two sources, and thus a perceptible difference between the left and the right channel acoustic outputs from a single woofer system.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a perspective view of a passenger compartment of a motor vehicle including one embodiment of a compact audio woofer arrangement of the present invention.

FIG. 2 is a plot of a sample frequency response of one of the two acoustic termination points of FIG. 1.

FIG. 3 is a plot of a sample frequency response of the other one of the two acoustic termination points of FIG. 1.

FIG. 4 is a flow chart of one embodiment of a method of the present invention for providing audio in a motor vehicle.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

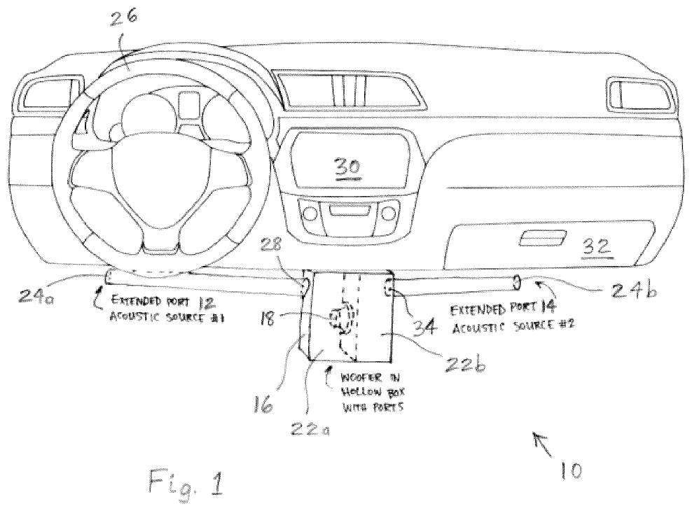

FIG. 1 illustrates one embodiment of a compact audio woofer arrangement 10 of the present invention, including a left extended port 12 and a right extended port 14 extending out of opposite sides of a hollow enclosure 16 having a woofer 18 and terminating at acoustic points 24a-b (FIG. 1). The two extended, individually tuned ports 12, 14 may provide discrete audio transmission paths to two predetermined points in the vehicle cabin. Enclosure 16 may be configured as a double-tuned bandpass woofer.

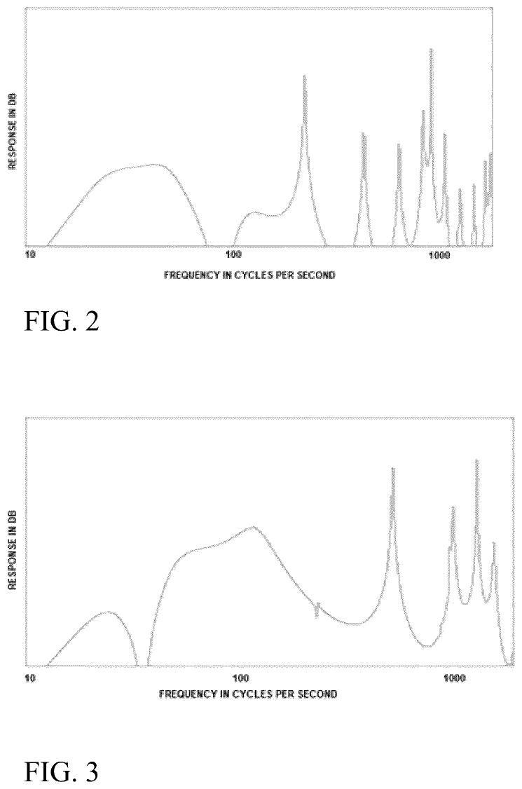

Two discrete acoustic termination points 24a-b are created under the dash, with one acoustic termination output 24a being disposed in or near the driver side and the other acoustic termination output 24b being disposed in or near the passenger side. A sample frequency response of each acoustic termination point is illustrated in FIGS. 2 and 3. As shown, the spectral response of each of these sources is intentionally dissimilar, with each source being tuned to a unique resonant frequency, which is consistent with the typical behavior of a double-tuned bandpass woofer. FIGS. 2-3 show one possible tuning that is consistent with the application of this invention, but the invention is not limited to the precise resonant frequencies illustrated in FIGS. 2-3. Further alterations can be made to the dynamics and equalization of the woofer through the use of digital signal processing (DSP). For instance, by emphasizing certain frequencies of one input channel and de-emphasizing the same frequencies in the other input channel, the quasi-stereo effect can be enhanced between acoustic point #1 and acoustic point #2.

Port 12 is a hollow conduit including an open left end 24a into the foot well below steering wheel 26 on a driver side of the motor vehicle, and a right end 28 extending into a through-hole in hollow enclosure 16 below a central touch display 30. Open end 24a may be disposed remote from enclosure 16. For example, open end 24a may be disposed approximately between one-half foot and five feet from enclosure 16.

Port 14 is a hollow conduit including an open right end 24b into the foot well below glove enclosure 32 on a passenger side of the motor vehicle, and a left end 34 extending into a through-hole in hollow enclosure 16 below central touch display 30. Open end 24b may be disposed remote from enclosure 16. For example, open end 24b may be disposed approximately between one-half foot and five feet from enclosure 16.

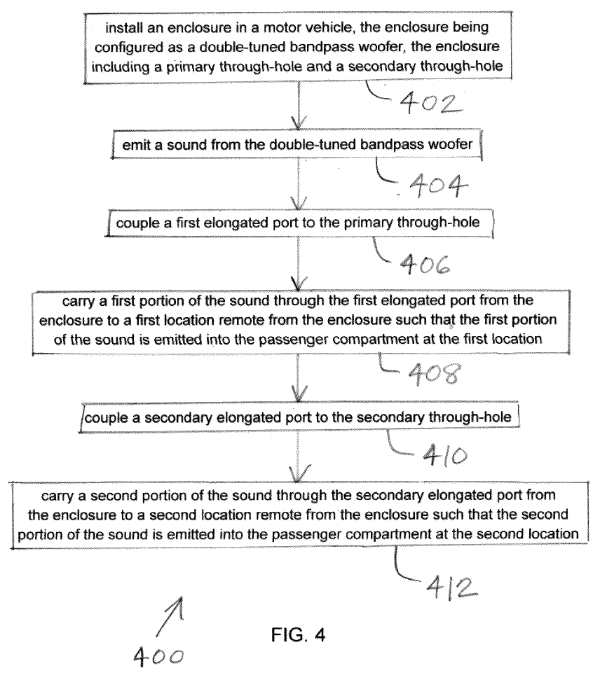

FIG. 4 is a flow chart of one embodiment of a method 400 of the present invention for providing audio in a motor vehicle. In a first step 402, an enclosure is installed in the motor vehicle. The enclosure is configured as a double-tuned bandpass woofer. The enclosure includes a primary through-hole and a secondary through-hole. For example, enclosure 16 is installed in a motor vehicle, as shown in FIG. 1. Enclosure 16 may be configured as a double-tuned bandpass woofer. Enclosure 16 includes a primary through-hole which receives right end 28 of port 12, and a secondary through-hole which receives left end 34 of port 14.

Next, in step 404, a sound is emitted from the double-tuned bandpass woofer. For example, sound may be emitted from woofer 18 within enclosure 16.

In a next step 406, a first elongated port is coupled to the primary through-hole. For example, right end 28 of elongated port 12 is received in a through-hole of enclosure 16.

In step 408, a first portion of the sound is carried through the first elongated port from the enclosure to a first location remote from the enclosure such that the first portion of the sound is emitted into the passenger compartment at the first location. For example, a first portion of the sound from woofer 18 is carried through elongated port 12 from enclosure 16 to an open end 24a that is disposed remote from enclosure 16 such that the first portion of the sound is emitted into the passenger compartment at open end 24a.

Next, in step 410, a secondary elongated port is coupled to the secondary through-hole. For example, left end 34 of elongated port 14 is received in another through-hole of enclosure 16.

In a final step 412, a second portion of the sound is carried through the secondary elongated port from the enclosure to a second location remote from the enclosure such that the second portion of the sound is emitted into the passenger compartment at the second location. For example, a second portion of the sound from woofer 18 is carried through elongated port 14 from enclosure 16 to an open end 24b that is disposed remote from enclosure 16 such that the second portion of the sound is emitted into the passenger compartment at open end 24b.

Although the invention has been shown in FIG. 1 as carrying sound horizontally between two front seats of a motor vehicle, it is to be understood that the invention may be applied to carry sound between any two locations within a passenger compartment of a motor vehicle. For example, the invention may be used to carry sound between back seats; between a front seat and a back seat; between two different vertical levels; or between any combination of the above.

Although the invention has been shown in the drawings as including a linear elongated port with an interior channel having a constant, circular cross section, it is to be understood that elongated ports having other shapes and cross sections are within the scope of the invention. For example, the elongated ports may have bends and/or arcuate sections that may be needed to get around other components in the motor vehicle. It is also possible for the interior channels of the elongated ports to have square, rectangular, triangular, or oval cross sections. It is also possible for the interior channels of the elongated ports to vary along their lengths in terms of shape and/or width or other dimension.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A compact audio woofer arrangement for a motor vehicle, the arrangement comprising:
an enclosure configured to be installed in the motor vehicle, the enclosure configured as a double-tuned bandpass woofer configured to emit a sound, the enclosure including a primary through-hole and a secondary through-hole;
a first elongated port coupled to the primary through-hole, the first elongated port being configured to carry a first portion of the sound from the enclosure to a first location remote from the enclosure such that the first portion of the sound is emitted into the passenger compartment at the first location; and
a second elongated port coupled to the secondary through-hole, the secondary elongated port being configured to carry a second portion of the sound from the enclosure to a second location remote from the enclosure such that the second portion of the sound is emitted into the passenger compartment at the second location.

2. The arrangement of claim 1 wherein the first acoustic output location is at least 12 inches from the second location.

3. The arrangement of claim 1 wherein the enclosure is substantially centrally located between a driver side and a passenger side of the motor vehicle and is disposed forward of a front seat of the motor vehicle, under the dash, or within the center console adjacent to each seat.

4. The arrangement of claim 1 wherein the first acoustic output location is on a driver side of the motor vehicle and is disposed forward of a front seat of the motor vehicle, and the second acoustic output location is on a passenger side of the motor vehicle and is disposed forward of the front seat of the motor vehicle.

5. A method of providing audio in a motor vehicle, the method comprising:
installing an enclosure in the motor vehicle, the enclosure being configured as a double-tuned bandpass woofer, the enclosure including a primary through-hole and a secondary through-hole;
emitting a sound from the double-tuned bandpass woofer;
coupling a first elongated port to the primary through-hole;
carrying a first portion of the sound through the first elongated port from the enclosure to a first location remote from the enclosure such that the first portion of the sound is emitted into the passenger compartment at the first location;
coupling a secondary elongated port to the secondary through-hole; and
carrying a second portion of the sound through the secondary elongated port from the enclosure to a second location remote from the enclosure such that the second portion of the sound is emitted into the passenger compartment at the second location.
